(19) United States
(12) Patent Application Publication
(10) Pub. No.: US 2003/0058893 A1
(43) Pub. Date: Mar. 27, 2003

(54) Synchronization of multiple cable modem termination systems

(75) Inventors: David R. Dworkin, Alpharetta, GA (US); Paul E. Burrell, Duluth, GA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Broadcom Corporation

(21) Appl. No.: 10/254,802

(22) Filed: Sep. 26, 2002

Related U.S. Application Data
(60) Provisional application No. 60/325,008, filed on Sep. 27, 2001.

(51) Int. Cl. H04J 3/06

(52) U.S. Cl. 370/503

(57) ABSTRACT

A system and method for synchronizing multiple cable modem termination system (CMTS) devices is provided. In an embodiment, a calibration pulse issued from a calibration pulse generator is received by one or more CMTS devices. Upon receiving the calibration pulse, each CMTS device stores the present value of a counter. Next, each slave CMTS device generates and stores a future time stamp value. The future time stamp value represents a future time when each slave CMTS device will update the value of its counter. When the future time stamp value stored in a particular CMTS device is equal to the value of the CMTS devices counter, an internal signal will be issued by the CMTS device. Upon issuance of the internal signal, the counter of each of the one or more slave CMTS devices is synchronized with one another by resetting each counter to a previously stored new counter value.

### RELATED APPLICATIONS

This application claims priority to U.S. Provisional Application No. 60/325,008, filed Sep. 27, 2001, by Dworkin et. al. and incorporated herein by reference in its entirety.

This application is related to the following US Non-Provisional Patent Applications:

U.S. patent application Ser. No. 09/430,821, filed Oct. 29, 1999, by Hebsgaard et. al., and incorporated herein by reference in its entirety;

U.S. patent application Ser. No. 09/574,558, filed May 19, 2000, by Hebsgaard et al., and incorporated herein by reference in its entirety; and

U.S. patent application Ser. No. 09/653,155, filed Aug. 31, 2000, by Hebsgaard et al., and incorporated herein by reference in its entirety.

### BACKGROUND OF THE INVENTION 1. Field of the Invention

The present invention is generally related to communication systems. More particularly, the present invention is related to cable modem systems and methods for synchronizing multiple cable modem termination systems.

2. Background

In conventional cable modem systems, a hybrid fiber-coaxial (HEFC) network provides a point-to-multipoint topology for supporting data communication between a cable modem termination system (CMTS) at the cable headend and multiple cable modems (CM) at the customer premises. In such systems, information is broadcast downstream from the CMTS to the cable modems as a continuous transmitted signal in accordance with a time division multiplexing (TDM) technique. In contrast, information is transmitted upstream from each of the cable modems to the CMTS as short burst signals in accordance with a time domain multiple access (TDMA) technique. Typically, between 250 and 500 cable modems communicate with a single CMTS device. The upstream transmission of data from the cable modems is managed by the CMTS, which allots to each cable modem specific slots of time within which to transfer data. In the event the CMTS were to become disabled, the cable modems would lose connectivity to the cable headend. Therefore it is desirable to have multiple CMTS devices enabled to serve as a backup to one another. In this way, redundancy is achieved. The concept of time is central to the exchange of upstream communications between the cable modems and the CMTS. More specifically, the CMTS allocates certain time intervals in which a particular cable modem may transmit data. Similarly, additional time intervals are established for performing ranging operations and for receiving transmissions from any cable modem. A time generation clock (TGC) counter is one device used to maintain the sense of time in the CMTS. Generally, the TGC counter cycles through its clock cycle in response to pulses received from an oscillator. In order for one CMTS device to assume the load of another CMTS device, the sense of time cannot be more than slightly off; otherwise, the transfer of responsibility will not work. Thus, synchronization of the TGC counter values in the respective devices is important.

U.S. patent application Ser. No. 09/653,155, commonly assigned and naming as an inventor, David R. Dworkin, discloses solutions for synchronizing multiple CMTS devices. In general, an offset is added to the TGC counter value of one of the CMTS devices. The result is a value representing some time in the future. This “future value” is provided to other CMTS devices which store the future value for later use. Eventually, the TGC counter value of the first CMTS device will be equal to the determined future value. When this happens, the first CMTS device generates a signal that is transmitted to the other CMTS devices. Upon receipt, the other CMTS devices will load their TGC counter with the previously stored “future value.” This process involves the first CMTS device providing the “future value” and a signal to the other CMTS devices to trigger the loading of a new value into the TGC counter. While effective, this solution is not without problems. For example, because the signal that triggers the loading feature is generated externally to the other CMTS devices, its receipt is subject to delays associated with network latency and software and programming configurations. Thus, additional needs exist for synchronizing time between multiple CMTS devices.

### BRIEF SUMMARY OF THE INVENTION

The present invention provides a system and method for synchronizing multiple cable modem termination systems (CMTS) devices. In accordance with embodiments of the present invention, synchronization is achieved by having multiple CMTS devices adjust their times to the same value and at approximately the same point in time. Thus, the concept of “same value-same point” can be used to summarize the present invention. To elaborate, the TGC counters of the CMTS devices in the cable modem system are likely to have different values after initializing and will therefore require synchronization. In an embodiment, a calibration pulse issued from a calibration pulse generator is received by one or more CMTS devices. Upon receiving the calibration pulse, each CMTS device stores the current value of its TGC counter in a designated register. By referencing the values stored in the designated register, any time differential existing between the CMTS devices can be determined. If time differentials exist, then synchronization is required. To continue, an offset is added to the TGC counter value of a master CMTS device. In an embodiment, the offset is a value sufficient enough to allow time for registers of other CMTS devices (slaves) to be programmed. Adding the offset and TGC counter value of the master CMTS device yields a future time stamp value (FTSV) equal to a time that the master will reach at some point in the future. This time is provided to the slave CMTS devices where it is stored for future use as a new TGC counter value. Thus, the new TGC counter value is used to ensure that master and slave CMTS devices will be synchronized to the same value. The offset value is also added to the TGC counter values of the slave CMTS devices, thus yielding a future time stamp value for each slave CMTS. Each slave CMTS stores its respective future time stamp value so that it can execute a reset or loading of its TGC counter without further intervention from the master CMTS. The future time stamp values represent values to which the TGC counters of the slave CMTS devices will eventually be equal. When this occurs, each slave CMTS device will reset its TGC counter value equal to its new TGC counter value. In an embodiment, the resetting or loading of the TGC counters is achieved by configuring each CMTS device to issue an internal signal. Upon issuance of the respective internal signals, the local TGC counter at each of the one or more slave CMTS devices will be reset to the stored new TGC count value. In this way, each of the one or more slave CMTS devices is now synchronized to the Master CMTS device since they all have the same TGC counter value. The common offset value ensures that the CMTS devices will be resetting their individual TGC counter values at a common point in time despite any differences in their respective TGC counter values prior to the reset. Where for example, you take the time of the master CMTS device (A) and add an offset (B) to it, you obtain some future time (C) that has not yet been reached. Adding the same offset (B) to the time (X) of any selected slave CMTS device would yield some future time (Y) for the slave CMTS device that has also not yet been reached. From this it should be apparent that while (C) and (Y) are most likely different values, (C) is (B) ahead of (A) just as (Y) is (B) ahead of (X). Thus, the master and slave CMTS devices will each reach their respective future times (C) and (Y) at the common point (B).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a high-level block diagram of a cable modem system in accordance with embodiments of the present invention.

FIG. 2 is a schematic block diagram of a cable modem termination system (CMTS) in accordance with embodiments of the present invention.

FIG. 3 is a schematic block diagram further detailing a synchronization circuit in accordance with embodiments of the present invention.

FIG. 4 is a flow chart diagram of a method for synchronizing multiple CMTS devices in accordance with embodiments of the present invention.

FIG. 5 is a flow chart diagram further describing the method of FIG. 4 in accordance with embodiments of the present invention.

### DETAILED DESCRIPTION OF THE INVENTION

The present invention will now be described with reference to the accompanying drawings. In the drawings, like reference numbers indicate identical or functionally similar elements. Additionally, the left-most digit(s) of a reference number identifies the drawing in which the reference number first appears.

### Table of Contents

A. Cable Modem System in Accordance with Embodiments of the Present Invention

B. Example Cable Modem System Components in Accordance with Embodiments of the Present Invention

1. External Load Configuration

2. External Verify Configuration

3. Internal Load Configuration

4. Internal Verify Configuration

C. Example Synchronization Method in Accordance with Embodiments of the Present Invention.

D. Conclusion

Terminology

The following terms are defined so that they may be used to describe embodiments of the present invention. As used herein:

“ExtLdVerTsIn” refers to an External Pulse source from either a pulse generator or another CMTS.

“TsLoad” refers to an Internal pulse source generated by a software write command to the appropriate bit in a TGCControl register.

“TsVerify” is a net name. The TsVerify pulse is synchronized to load a TGC value into a verify register.

“TsVerRegLd” refers to the pulse that loads the TsVerify register.

“intver” refers to a signal path for internal verify.

“intld” refers to a signal path for internal load.

“extver” refers to a signal path for external verify.

“extld” refers to a signal path for external load.

“ld_ts” refers to a signal that loads the TGC counter with the contents of a TGCLoad register.

A. Cable Modem System in accordance with Embodiments of the Present Invention

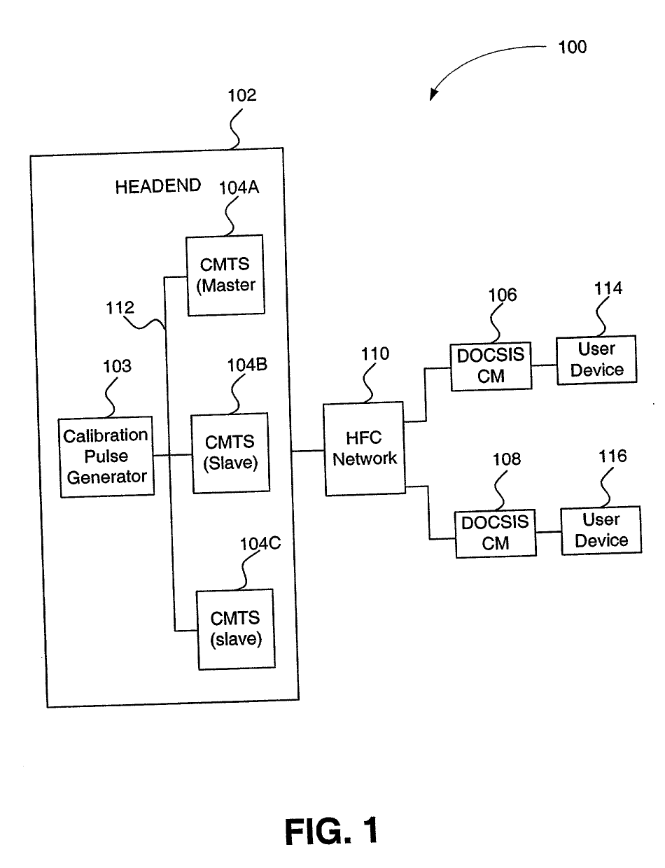

FIG. 1 is a high level block diagram of an example cable modem system 100 in accordance with embodiments of the present invention. The cable modem system 100 enables voice communications, video, and data services to be provided based on a bi-directional transfer of Internet protocol (IP) traffic between a cable system headend 102 and a plurality of cable modems 106 and 108 over a hybrid fiber-coaxial (HFC) cable network 110. In the example cable modem system 100, only two cable modems 106 and 108 are shown for clarity. In general, any number of cable modems may be included in the cable modem system of the present invention.

In accordance with an embodiment of the present invention, the cable headend 102 comprises a calibration pulse generator 103 and at least one cable modem termination system (CMTS). Calibration pulse generator 103 can be software or any other device capable of generating a single pulse of specific width, at a specific time. In the disclosed embodiment, software is used to issue a negative logic 90 ns calibration pulse to the CMTS. The CMTS is the portion of the cable headend 102 that manages the upstream and downstream transfer of data between the cable headend 102 and the cable modems 106 and 108, which are located at the customer premises.

The CMTS broadcasts information downstream to the cable modems 106 and 108 as a continuous transmitted signal in accordance with a time division multiplexing (TDM) technique. Additionally, the CMTS controls the upstream transmission of data from the cable modems 106 and 108 to itself by assigning to each cable modem 106 and 108 short grants of time within which to transfer data. In accordance with this time domain multiple access (TDMA) technique, each cable modem 106 and 108 may only send information upstream as short burst signals during a transmission opportunity allocated to it by the CMTS.

In the example cable modem system 100, three CMTS devices 104A, 104B, and 104C are shown (referred to herein collectively as 104). In general, any number of CMTS devices 104 may be included in the cable modem system 100 of the present invention. In an embodiment of the present invention, CMTS 104A is designated as the master CMTS device and CMTS devices 104B and 104C are designated as the slave CMTS devices. After reading this disclosure, it will be apparent to one skilled in the relevant art(s) that the number of slave CMTS devices will vary depending on the requirements of a particular HFC network. Furthermore, as the requirements for a particular HFC network change, additional CMTS devices 104 may be incorporated into the cable modem system. In this way, cable modem system 100 is readily expandable. In the example cable modem system 100, CMTS 104A, CMTS 104B, and CMTS 104C are depicted as embodied in a single device or “Headend” 102. This may not always be the case. In alternative embodiments, CMTS 104A, CMTS 104B, and CMTS 104C can reside in separate devices. The master CMTS device 104A, the slave CMTS device 104B and 104C, and calibration pulse generator 103 are connected to one another by a synchronization bus 112. The term synchronization bus refers to any suitable path for the transmission of electronic pulses and data between calibration pulse generator 103, CMTS 104A, CMTS 104B, and CMTS 104C. Accordingly, synchronization bus 112 could be, for example, a peripheral component interface (PCI), back-plane bus, four-wire interface, coaxial cable, or wireless path.

As noted above, cable modem system 100 includes HFC network 110. The HFC network 110 provides a point-to-multipoint topology for the high-speed, reliable, and secure transport of data between the cable headend 102 and the cable modems 106 and 108 at the customer premises. As will be appreciated by persons skilled in the relevant art(s), the HFC network 110 may comprise coaxial cable, fiberoptic cable, or a combination of coaxial cable and fiberoptic cable linked via one or more fiber nodes.

Cable modem system 100 also includes cable modems 106 and 108. Each of the cable modems 106 and 108 operate as an interface between the HFC network 110 and at least one attached user device. In particular, the cable modems 106 and 108 perform the functions necessary to convert downstream signals received over the HFC network 110 into IP data packets for receipt by an attached user device. Additionally, the cable modems 106 and 108 perform the functions necessary to convert IP data packets received from the attached user device into upstream burst signals suitable for transfer over the HFC network 110. In the example cable modem system 100, each cable modem 106 and 108 is shown supporting only a single user device 114 and 116. In general, each cable modem 106 and 108 is capable of supporting a plurality of user devices for communication over the cable modem system 100. User devices may include personal computers, data terminal equipment, telephony devices, broadband media players, network-controlled appliances, or any other device capable of transmitting or receiving data over a packet-switched network.

B. Example Cable Modem System Components in Accordance with Embodiments of the Present Invention

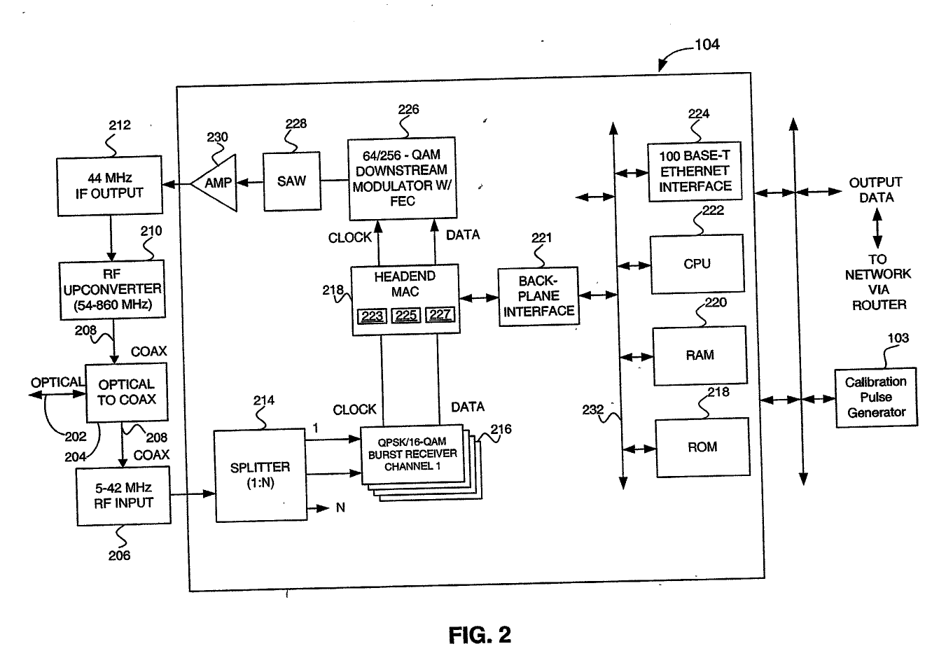

FIG. 2 depicts a schematic block diagram of an implementation of the CMTS 104 of cable modem system 100 shown in FIG. 1. The disclosed implementation is presented by way of example and is not intended to limit the present invention. The CMTS 104 is configured to receive and transmit signals to and from the HFC network 110, a portion of which is represented by the optical fiber 202 of FIG. 2. Accordingly, the CMTS 104 will be described in terms of a receiver portion and a transmitter portion.

The receiver portion includes an optical-to-coax stage 204, an RF input 206, a splitter 214, and a plurality of burst receivers 216. Reception begins with the receipt of upstream burst signals originating from one or more cable modems by the optical-to-coax stage 204 via the optical fiber 202. The optical-to-coax stage 204 routes the received burst signals to the radio frequency (RF) input 206 via coaxial cable 208. In embodiments, these upstream burst signals have spectral characteristics in the frequency range of roughly 5-42 MHz.

The received signals are provided by the RF input 206 to the splitter 214 of the CMTS 104, which separates the RF input signals into N separate channels. To recover the underlying information signals, each of the N separate channels is then provided to a separate burst receiver 216 which operates to demodulate the received signals on each channel in accordance with either a Quadrature Phase Shift Key (QPSK) or a Quadrature Amplitude Modulation (QAM) technique operating anywhere in the range of 16-QAM to 256-QAM. Each burst receiver 216 also converts the underlying information signals from an analog form to digital form. This digital data is subsequently provided to the headend media access control (MAC) 218.

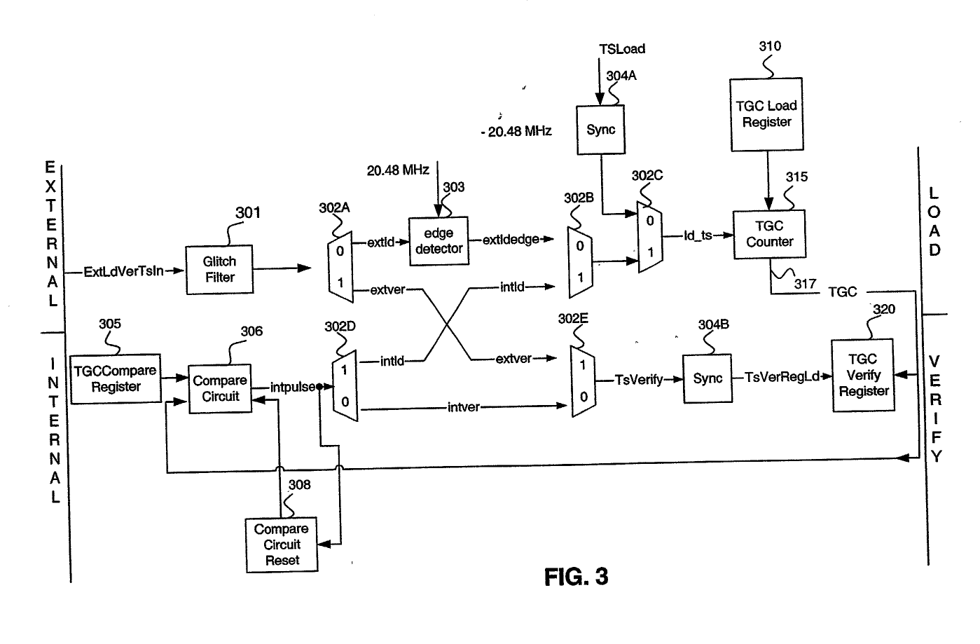

In accordance with embodiments of the present invention, one function of the headend MAC 218 is to synchronize the respective TGC counters of CMTS devices 104B and 104C with CMTS device 104A. The TGC counters are used to maintain the sense of time in the CMTS devices 104. The functions of the headend MAC 218 may be implemented in hardware or in software. In the example implementation of FIG. 2, the functions of the headend MAC 218 are implemented both in hardware and software. Accordingly, in an embodiment, MAC 218 is provided with a synchronization circuit 223. Synchronization circuit 223 provides the synchronization functions of MAC 218 and will be described in further detail below with respect to FIG. 3. MAC 218 is further provided with a TGCControl register 225. The TGCControl register 225 is used to control the functions of several multiplexers located within the synchronization circuit 223. In an embodiment, MAC 218 is also provided with a TGCMasking register 227. The TGCMasking register 227 is used to control the periodic rate of pulse generation in the compare circuit 306 (shown in FIG. 3). Software functions of the headend MAC 218 may be stored in either the random access memory (RAM) 220 or the read-only memory (ROM) 218 and executed by the CPU 222. The headend MAC is in electrical communication with these elements via a backplane interface 221 and a shared communications medium 232. In embodiments, the shared communications medium 232 may comprise a computer bus or a multiple access data network.

The headend MAC 218 is also in electrical communication with the Ethernet interface 224 via both the backplane interface 221 and the shared communications medium 232. When appropriate, Ethernet packets recovered by the headend MAC 218 are transferred to the Ethernet interface 224 for delivery to the packet-switched network via a router.

The transmitter portion of the CMTS 104 includes a downstream modulator 226, a surface acoustic wave (SAW) filter 228, an amplifier 230, an intermediate frequency (IF) output 212, a radio frequency (RF) upconverter 210 and the optical-to-coax stage 204. Transmission begins with the generation of a digital broadcast signal by the headend MAC 218. The digital broadcast signal may include data originally received from the packet-switched network via the Ethernet interface 224. The headend MAC 218 outputs the digital broadcast signal to the downstream modulator 226 which converts it into an analog form and modulates it onto a carrier signal in accordance with either a 64-QAM, 256-QAM technique, or higher.

The modulated carrier signal output by the downstream modulator 226 is input to the SAW filter 228 which passes only spectral components of the signal that are within a desired bandwidth. The filtered signal is then output to an amplifier 230 which amplifies it and outputs it to the IF output 212. The IF output 212 routes the signal to the RF upconverter 210, which upconverts the signal. In embodiments, the upconverted signal has spectral characteristics in the frequency range of approximately 54-860 MHz. The upconverted signal is then output to the optical-to-coax stage 204 over the coaxial cable 208. The optical-to-coax stage 204 broadcasts the signal via the optical fiber 202 of the HFC network 110.

Related to the need of loading time to achieve synchronization is the need of verifying time. With respect to multiple CMTS devices, time needs to be verified to determine what time differences, if any, exist between the CMTS devices. Similarly, once synchronization is achieved, time needs to be periodically verified to ensure that synchronization is being maintained. The TGC counters previously discussed are but part of a larger system for maintaining the concept of time in the CMTS. FIG. 3 will now be used to describe additional elements and features related to the loading and verifying of values in TGC counters in accordance with embodiments of the present invention.

FIG. 3 depicts a schematic block diagram of an implementation of the synchronization circuit 223, which is presented by way of example only and thus not intended to limit the present invention. In the disclosed embodiment, synchronization circuit 223 is provided with a glitch filter 301. Glitch filter 301 is used to ensure that the synchronization circuit 223 only responds to a pulse having sufficient properties to initiate the functions of the present invention. More particularly, Glitch filter 301 is programed to monitor for pulses having a specific duration of high and low signals. In accordance with embodiments of the present invention, the glitch filter 301 only allows an ExtLdVerTsIn pulse to initiate the external functions of the present invention.

In another alternative embodiment, the glitch filter 301 is disabled (by passed) and the ExtLdVerTsIn pulse is provided by master CMTS 104A. In another alternative embodiment, the glitch filter 301 is disabled (by passed) and the ExtLdVerTsIn pulse is provided by calibration pulse generator 103. In these last two embodiments, the glitch filter 301 is disabled in order to provide fully synchronous pulse detection from either CMTS 104A or the pulse generator 103.

The synchronization circuit 223 is further configured to receive and transmit signals over an external load path, an external verify path, an internal load path, and an internal verify path using a number of multiplexers referred to herein as mux 302A, mux 302B, mux 302C, mux 302D, and mux 302E. The function and control of each mux is directed by the TGCControl register 225 (FIG. 2). The TGCControl register is configured to provide a signal (0 or 1) to mux 302A-302E. This signal determines which of the four available paths an electronic pulse passing through synchronization circuit 223 will travel. In this way, the present invention is responsive to both externally and internally generated signals. Accordingly, the synchronization circuit 223 will be further described in terms of operating in an external load mode, an external verify mode, an internal load mode, and an internal verify mode.

External Load Configuration

The external load mode is useful for having a source, external to the CMTS device whose sense of time is being adjusted, drive the synchronization process. In an embodiment of the present invention, master CMTS device 104A can be used to provide an external pulse. Any slave CMTS device (such as 104B or 104C) operating in external load mode will traverse its external load path upon receiving the external pulse. More specifically, when configured for external load mode, the synchronization circuit 223 is programed to load a specified value into the TGCCounter 315 in response to receiving the externally generated pulse.

To begin, glitch filter 301 will pass an ExtLdVerTsIn pulse to mux 302A. Continuing along the external load path, mux 302A outputs an external load pulse (extld) to an edge detection unit 303. The edge detection unit 303 is used to synchronize to a 20.48 MHz clock domain and to provide a rising edge. In this way, the edge detection unit 303 allows a register (e.g., TGCCounter 315) to be loaded by logic that uses one clock domain (e.g., 20.48 MHz) but is generated by logic using a different clock domain (e.g., 100 MHz). The output of edge detection unit 303 is an external load edge (extldedge) signal. This signal is provided to the input of mux 302B. The output of mux 302B is provided to a mux 302C.

In addition to the output signal from mux 302B, mux 302C also receives a time stamp load (TSLoad) signal synchronized by sync block 304A. In an embodiment, the TSLoad is a pulse initiated by a software command. The sync block 304A is used to allow a register (e.g., TGCCounter 315) to be loaded by logic that uses one clock domain (e.g., 20.48 MHz) but is generated by logic using a different clock domain (e.g., 100 MHz).

The output of mux 302C is a load time stamp pulse (ld_ts). With respect to the issuance of ld_ts, the (0) input of mux 302C will pass the synchronized software pulse TsLoad. The (1) input of 302C will pass the synchronized external pulse. The issuance of ld_ts causes the value stored in a TGCLoad register 310 to be loaded into a TGCCounter 315. TGCCounter 315 maintains the current time stamp value of a CMTS device 104.

TGCLoad register 310 is used to receive a new TGCCounter value to which TGCCounter 315 will be reset at some future designated time. The value of TGCCounter 315 is propagated throughout the system over TGCbus 317. In this way, traversals of the external load path results in an external pulse being used to load a value into the TGCCounter 315.

External Verify Configuration

The external verify mode is useful for enabling one CMTS device to obtain a snapshot capturing the sense of time at a particular point between itself and other CMTS devices in the cable modem system. In an embodiment of the present invention, master CMTS device 104A can be used to provide an external pulse. Any slave CMTS device (such as 104B or 104C) operating in external verify mode will traverse its external verify path upon receiving the external pulse. More specifically, when configured for external verify mode, the synchronization circuit 223 is programed to load the present value of the TGCCounter 315 into the TGCVerify Register 320 in response to receiving the externally generated pulse.

In traversing the external verify path, glitch filter 301 provides the ExtLdVerTsIn pulse to the input of mux 302A. In turn, mux 302A passes an external verify pulse (extver) to mux 302E. Mux 302E issues a time stamp verify (TsVerify) signal to sync block 304B. The TsVerify signal is output at the system clock time base (e.g., 100 MHz). Therefore, the TsVerify signal is provided to synch block 304B in order to synchronize the TsVerify signal to the 20.48 MHz time domain. The synch block 304B provides a time stamp verify load pulse (TsVerRegLd). Upon issuance of TsVerRegLd, the current value of TGCCounter 315 is stored into a TGCVerify Register 320. This current value can be used as a base reference time value (or snapshot) for determining a time differential between the master CMTS 104A and the slave CMTS devices 104B and 104C. In summary, the traversals of the external verify path result in an external pulse being used to load the TGC Verify Registers 320 with the base reference time value.

Internal Load Configuration

The internal load mode is useful for having the CMTS device whose sense of time is being adjusted drive the synchronization process. In an embodiment of the present invention, any CMTS device (such as slave CMTS devices 104B and 104C) operating in internal load mode can issue an internal pulse which will cause traversals of its internal load path. More specifically, when configured for internal load mode, the synchronization circuit 223 is programed to load a specified value into its TGCCounter 315 in response to receiving an internally generated pulse initiated through software.

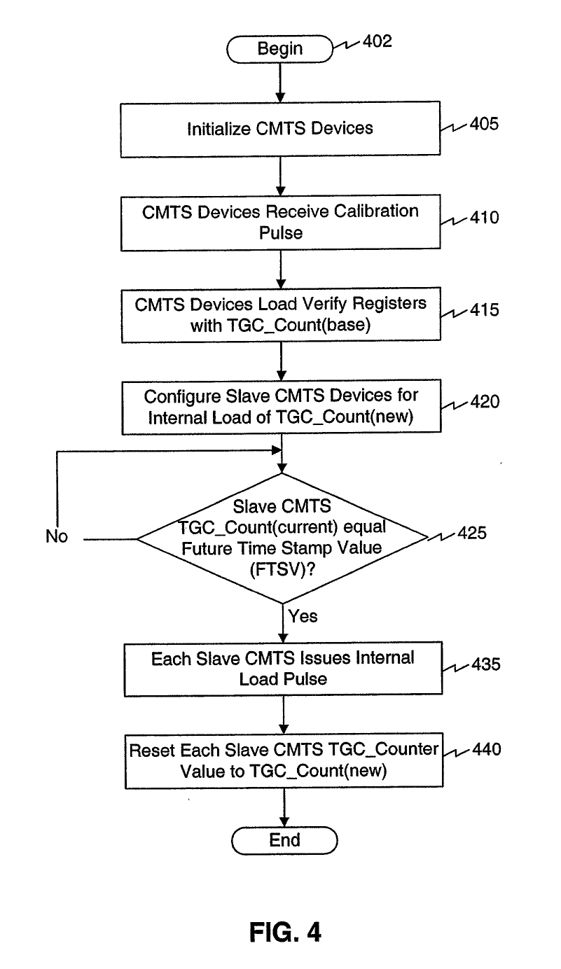

The internal load path is headed by a TGCCompare register 305. TGCCompare register 305 is used to hold a future time stamp value (FTSV) for the slave CMTS devices 104. The process of determining the FTSV is described below with respect to FIG. 4. Proceeding along the internal load path, the value of TGCCompare register 305 and the value of TGCCounter 315 (by way of TGCbus 317) are each provided into a compare circuit 306. Compare circuit 306 is provided with logic to determine when the TGCCompare register 305 value and the TGCCounter 315 value are equal to one another. When the compare circuit 306 determines that its two input values are equal, an internal pulse (intpulse) is issued.

The TGCCounter 315 is designed to continuously repeat its clock cycle, causing the TGCCompare register 305 and TGCCounter values to become equal over and over again. Therefore, to prevent repeated issuance of the internal pulse, the synchronization circuit 223 further includes a compare circuit reset 308. Compare circuit reset 308 is used to disable compare circuit 306 upon issuance of the internal pulse.

Continuing along the internal load path, the internal pulse is provided to mux 302D. The mux 302D responds by providing an internal load output signal to mux 302B. The output of mux 302B is provided to a mux 302C. In addition to the output signal from mux 302B, mux 302C also receives a TSLoad signal from sync block 304A. In an embodiment, the TSLoad signal is a software initiated pulse which is independent of the intpulse signal. The TSLoad signal is useful as an alternative mechanism for loading the TGCCounter 315. The sync block 304A is used to allow a register to be loaded by logic that uses one clock domain but is generated by logic using a different clock domain. The output of Mux 302C is a load time stamp pulse (ld_ts). The issuance of ld_ts causes the value stored in TGCLoad register 310 to be loaded into TGC Counter 315. In this way, traversal of the internal load path allows a pulse issued internally to the CMTS devices 104 to load TGCCounter 315.

Internal Verify Configuration

The internal verify mode is useful for enabling one CMTS device to obtain a snapshot capturing its time at a particular point. In an embodiment of the present invention, any CMTS device (such as slave CMTS devices 104B and 104C) operating in internal verify mode can issue an internal pulse which will cause traversals of its internal verify path. Specifically, when configured for internal verify mode, the synchronization circuit 223 is programed to load the present value of its TGCCounter 315 into its TGCVerify register 320 in response to receiving an internally generated pulse initiated through software. The internal verify mode is useful for periodic polling of the TGCCounter 315 value of the synchronization circuit 223.

The internal verify path is headed by the TGCCompare register 305. The value of TGCCompare register 305 and the value of TGCCounter 315 (by way of TGCbus 317) are each provided into a compare circuit 306. Compare circuit 306 is provided with logic to determine when the TGCCompare register 305 value and the TGCCounter 315 value are equal to one another. When the compare circuit 306 determines that its two input values are equal, an internal pulse (intpulse) is issued. Here again, compare circuit reset 308 is used to prevent further issuance of the internal pulse. The internal pulse is provided to mux 302D. The mux 302D responds by providing an internal verify signal to mux 302E. The output of mux 302E is a timestamp verify (TSVerify) pulse. The timestamp verify pulse is provided to synch block 304B. In response, synch block 304B outputs a time stamp verify register load pulse (TsVerRegLd). In response to the issuance of TsVerRegLd, TGCVerify register 320 is loaded with the value of TGCCounter 315. In this way, a pulse issued internally to the CMTS device 104 is able to load the TGC Verify register 320.

Alternatively, the internal verify configuration is also useful for generating an internal pulse at a specified TGCCounter value and providing that same pulse externally on the TGC_LOAD_VERIFY pin. The TGCCounter 315 is designed to continuously repeat its clock cycle causing the TGCCompare register 305 and TGCCounter values to become equal over and over again. Previously, it was discussed that a compare circuit reset 308 is provided to disable the compare circuit 306 upon issuance of the internal pulse. Alternatively, it may be desirable to exploit the fact that the TGCCounter 315 continuously repeats its clock cycle causing the TGCCompare register 305 and TGCCounter values to become equal over and over again. This desired behavior would result in a periodic internal pulse being generated. This same internally generated pulse can be used to output a periodic pulse on the TGC_LOAD_VERIFY pin. It will be understood by those skilled in the art that the periodic rate of such a pulse can be easily adjusted or varied by the compare circuit 306. If less than all 32 bits are used for comparison of the TGCCounter and TGCCompare register, the periodic rate at which the TGCCounter value and TGCCompare register value are equal will increase. The TGCMasking register 227 provides the means for configuration of the compare circuit 306 to function at variable periodic rates. The usefulness of this function manifests itself when it is desired to generate a periodic pulse on the TGC_LOAD_VERIFY pin at any periodic rate supported by the reference clock frequency used.

C. Example Synchronization Method in Accordance with Embodiments of the Present Invention.

FIG. 4 depicts a flowchart 400 of a method for synchronizing multiple CMTS devices in a cable modem system in accordance with embodiments of the present invention. The invention, however, is not limited to the description provided by the flowchart 400. Rather, it will be apparent to persons skilled in the relevant art(s) from the teachings provided herein that other functional flows are within the scope and spirit of the present invention. The flowchart 400 will be described with continued reference to the example CMTS devices 104 of the cable modem system 100, as well as with reference to the example hardware implementation of the synchronization circuit 223 of FIG. 3.

In step 405, CMTS devices 104A, 104B, and 104C are initialized. During initialization, the TGCControl register 225 for each CMTS device 104 is set to enable each CMTS device 104 to receive a calibration pulse. The CMTS devices 104 will likely complete their initialization routines at different times. If so, there will be a time differential between the TGCCounters 315 of each of the respective CMTS devices 104.

In step 410, each CMTS 104 simultaneously receives a calibration pulse (for example, ExtLdVerTsIn, from FIG. 3) on a TGC_LOAD_VERIFY pin. In the disclosed embodiment, the calibration pulse is issued from calibration pulse generator 103. In an alternative embodiment, master CMTS 104A can be used to generate the calibration pulse. The calibration pulse is used to configure the CMTS devices 104 for synchronization.

In step 415, the synchronization circuit 223 for master CMTS 104A is configured to operate in internal verify mode and each slave CMTS 104B and 104C is configured to operate in external verify mode. In this way, master CMTS device 104A can initiate the necessary pulse needed to trigger traversal of its internal verify path and the external verify path of each slave CMTS device 104B and 104C. Accordingly, upon issuance of a pulse, the synchronization circuit 223 for each CMTS 104 loads its TGCVerify register 320 with the current value of its TGCCounter 315. With respect to the slave CMTS devices 104B and 104C, the loading of TGCVerify register 320 is achieved through traversal of the external verify path. More specifically, glitch filter 301 provides the ExtLdVerTsIn pulse to the input of mux 302A. In turn, mux 302A passes an external verify pulse (extver) to mux 302E. Mux 302E issues a time stamp verify (TsVerify) signal to sync block 304B. The synch block 304B provides a time stamp verify load pulse (TsVerRegLd). Upon issuance of TsVerRegLd, the current value of TGCCounter 315 is stored into the TGCVerify Register 320. In the disclosed embodiment, the current TGCCounter 315 value is referred to as TGCCount(base). TGCCount(base) represents the current TGCCounter 315 value of the respective CMTS devices 104 at a base reference point in time. By comparing the respective TGCCount(base) values, the master CMTS device 104A can determine if it is synchronized with the slave CMTS devices 104B and 104C.

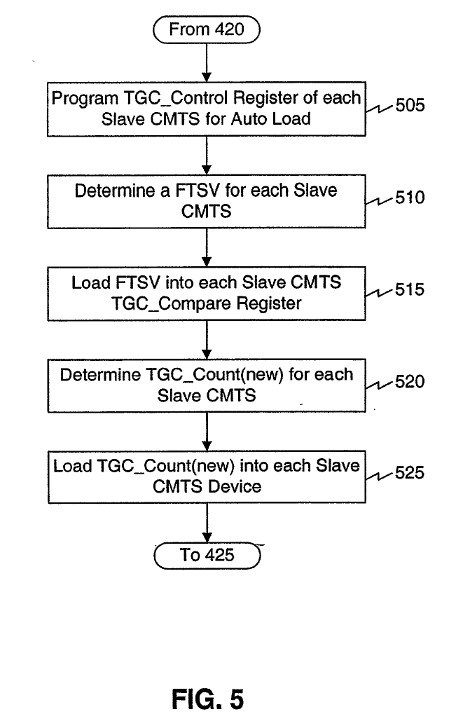

In step 420, each slave CMTS device 104B and 104C is configured to operate in internal load mode. This mode allows the value of TGCCounters 315 to be set to a new TGCCount value (TGCCount (new)) in response to an internal pulse (intpulse). Step 420 will now be described in further detail with reference to FIG. 5.

FIG. 5 provides a method for configuring each slave CMTS device 104B and 104C to perform an internal load of TGCCount (new).

In step 505, the TGCControl register 225 for each slave CMTS 104B and 104C is programmed to allow for an internal load of TGCCount (new) into TGCCounter 315 via an internal pulse (intpulse). More particularly, TGCControl register 225 is enabled to use mux 302D, mux 302B, and mux 302C to receive internally executed pulses.

In step 510, a Future Time Stamp Value (FTSV) is determined for each CMTS device. In an embodiment, each slave CMTS device 104B and 104C generates its own future time stamp value. Alternatively, the future time stamp value could be determined by the master CMTS device 104A or other appropriately designed external device without departing from the spirit and scope of the present invention. The FTSV is representative of a time in the future when a desired action is to be performed (e.g., loading of TGCCounter 315). In accordance with an embodiment of the present invention, for a given CMTS device 104, the FTSV is a function of its TGCCount(base) value and a program buffer value (Z). The Z value is any offset value sufficient enough to allow time for the registers of slave CMTS devices 104B and 104C to be programmed. For example, where TGC counter 315 is running at a 10.24 MHz rate, a program buffer value of 0X24924925 Hex would provide at least sixty seconds for programming of TGCControl registers 225.

The master CMTS device 104A can obtain the TGCCount(base) value for each slave CMTS device 104B and 104C from the respective TGCVerify Registers 320 (step 415). Accordingly, in an embodiment, the master CMTS 104A determines the FTSV for each respective slave. In another embodiment, each slave CMTS 104B or 104C is provided a common program buffer value (Z) and can determine its own FTSV value. Adding the same offset value (Z) to the respective times of the master CMTS device 104A and slave CMTS devices 104B and 104C ensures that for any one slave CMTS device, its FTSV will be ahead of its current time by the offset value (Z) just as the FTSV of the master will be ahead of its current time by the offset value (Z). Thus, where the FTSV for each respective CMTS device 104 is different, the master and slave CMTS devices will each reach their respective future times at a common point.

In step 515, the FTSV (i.e., TGCCount(base)+Z) for a particular slave CMTS 104B and 104C is programmed (i.e., loaded) into its respective TGCCompare register 305. In this way, the times for performing a particular action at the slave CMTS 104B and 104C are set.

In step 520, the TGCCount(new) value is determined for each slave CMTS 104B and 104C. The TGCCount(new) value represents the value each slave's TGCCounter 315 will have upon being reset. At some point in the future, it can be expected that the TGCCounter for the master CMTS device 104A will be equal to the master's FTSV. It is this future value to which the slave CMTS devices should be set to achieve synchronization. Therefore, in an embodiment, the TGCCount(new) value for each slave CMTS device is set equal to the FTSV of the master CMTS device 104A. Mathematically, the TGCCount(new) values can be viewed as a function of latency, the program buffer value (Z), and the time differential between the TGCCounter 315 values of the master CMTS 104A and the slave CMTS devices 104B and 104C. The concepts of latency and time differentials will now be discussed.

Latency is measured as the elapsed time between when a signal is sent and when it is received. Latency measurements also account for the time needed for receiving, recognizing, and responding to a signal. Accordingly, a latency correction value is utilized in the present invention to account for register synchronization requirements and board or system propagation delays which might be encountered whenever the master CMTS 104A and slave CMTS devices 104B and 104C are any appreciable distance apart. In the disclosed embodiment, where the calibration pulse is issued by calibration pulse generator 103, a latency correction value of one TGC count is appropriate. In contrast, where the calibration pulse is issued by Master CMTS 104A, a latency correction value of up to three TGC counts is necessary.

As previously mentioned, after initialization (step 405) each CMTS device 104 is likely to have a different TGCCounter value. In other words, a time differential will exist between each CMTS device 104. Referring back to step 415, the TGCCount value of each CMTS device 104 was loaded into each devices' TGCVerify register 320. Thus, the time differential between the CMTS devices 104 can be measured by comparing the TGCVerify register 320 values (i.e., TGCCount(base)) of each respective CMTS device 104. Accordingly, if for example, slave CMTS 104B has a TGCCount(base) that is less than the TGCCount(base) of master CMTS 104A, then the difference plus the latency correction and program buffer value (z) must be added to the TGCCount(base) of slave CMTS 104B in order to synchronize it with master CMTS 104A.

In step 525, the TGCCount(new) value for CMTS device 104B is loaded into its TGCLoad register 310. Likewise, an appropriate TGCCount(new) value for CMTS device 104C is loaded into its TGCLoad register 310. As described above, in accordance with an embodiment of the present invention, the respective TGCCount(new) values would be equal to the FTSV of the master CMTS 104A. Control then passes back to step 425 of FIG. 4. The remainder of routine 400 will now be described with continued reference to FIG. 4.

Recall that in step 420, each synchronization circuit 305 was configured to operate in internal load mode, thus in step 425, each slave will determine whether its TGCCounter 315 is equal to the FFSV stored in its TGCCompare register 305. The value of TGCCompare register 305 and the current value of TGCCounter 315 (by way of TGCbus 317) are each provided to the compare circuit 306. Compare circuit 306 is provided with logic to determine when the TGCCompare register 305 value and the TGCCounter 315 value (TGCCount(current)) are equal to one another.

In a step 435, an internal load pulse is issued by each slave CMTS 104B and 104C when its respective compare circuit 306 determines that its two input values are equal (i.e., the previously determined future time has been reached). Persons skilled in the relevant arts will recognize that the TGCCounter 315 is designed to continuously repeat its clock cycle. Consequently, the TGCCompare register 305 and TGCCounter values can be expected to become equal over and over again. Therefore, to prevent repeated issuance of the internal pulse, the synchronization circuit 223 will use the compare circuit reset 308 to disable compare circuit 306 upon issuance of the internal pulse.

Next, in a step 440, each slave CMTS 104B and 104C will reset the value of its TGCCounter 315 to the previously determined TGCCount(new) value. This will result in the synchronization of CMTS 104A, 104B and 104C. To achieve the reset, in an embodiment of the present invention, within each slave CMTS 104B and 104C, the internal pulse issued in step 435 is provided to mux 302D. The mux 302D responds by providing an internal load output signal to mux 302B. The output of mux 302B is provided to a mux 302C. In addition to the output signal from mux 302B, mux 302C also receives a TSLoad signal from sync block 304A. The sync block 304A is used to allow a register to be loaded by logic that uses one clock domain but is generated by logic using a different clock domain. The output of Mux 302C is a load time stamp pulse (ld_ts). The issuance of ld_ts causes each slave CMTS 104B and 104C to load its TGCCounter 315 with the TGCCount(new) value stored in its TGC Load register 310. In this way, the TGCCounter 315 of master CMTS 104A and slave CMTS 104B and 104C are each synchronized to provide system redundancy. If CMTS device 104A fails, one or more of the slave CMTS devices 104B and 104C can assume the load of CMTS 104A. Thus, requests from the cable modems 106 and 108 that were previously being serviced by CMTS 104A may continue without interruption. Likewise, CMTS 104A can serve as a back up to CMTS 104B and 104C.

In the disclosed embodiment, the same timebase is used for both the master CMTS device 104A and slave CMTS devices 104B and 104C. In this case, synchronization method 400 need not be repeated. This allows for setting the TGCCounter 315 values once, with only periodic checks to ensure that the slave CMTS devices 104B and 104C are still synchronized with master CMTS device 104A. Because each of the CMTS devices 104 are run from the same oscillator, it is presumed that each will remain in sync with the other for relatively long periods of time.

To verify that the CMTS devices 104 remain in sync, the values in the TGCVerify register 320 from each of the slave CMTS devices 104B and 104C are periodically verified through operation of an external verify as described above. In an embodiment, the TGCVerify registers 320 are periodically loaded with each device's TGCCounter 315 value. These values are then compared to the value in TGCVerify register 320 of master CMTS 104A. If the values are not identical, then synchronization method 400 may be repeated to regain synchronization.

D. Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method for synchronizing multiple cable modem termination system (CMTS) devices, comprising the steps of:
(i) receiving a calibration pulse at a master CMTS device and at least one slave CMTS device;
(ii) storing a base reference time value for said master CMTS device and said at least one slave CMTS device in response to said receiving step (i);
(iii) generating and storing a future time stamp value for said master CMTS device and said at least one slave CMTS device;
(iv) determining and storing a new time value for said at least one slave CMTS device based in part on a time differential between said stored base reference time value for said master CMTS and said stored base reference time value for said at least one slave CMTS device;
(v) generating a signal at said at least one slave CMTS device when said stored future time stamp value at said at least one slave CMTS device is equal to a current time value of said at least one slave CMTS device; and
(vi) resetting a local counter at said at least one slave CMTS device equal to said new time value stored at said at least one slave CMTS device in response to the signal generated in said signal generating step (v), wherein said master CMTS device and said at least one slave CMTS device are synchronized to said new time value.

2. The method of claim 1, wherein said calibration pulse originates from a calibration pulse generator.

3. The method of claim 1, wherein said calibration pulse originates from said master CMTS device.

4. The method of claim 3, wherein said future time stamp value for said at least one slave CMTS device is a function of its current time value and a program buffer value, wherein said program buffer value represents a time period needed to program said at least one slave CMTS device.

5. The method of claim 4, wherein said new time value for said at least one CMTS device is determined in said determining step (iv) as a function of latency, said program buffer value, and said time differential between said master CMTS device and said at least one slave CMTS device.

6. The method of claim 4, wherein said new time value for said at least one slave CMTS device is determined in said determining step (iv) as a function of latency, said program buffer value, and an absolute time value of said master CMTS device.

7. A system for synchronizing multiple cable modem termination system (CMTS) devices, the system comprising:
a master CMTS device configured to issue a calibration pulse; and
one or more slave CMTS devices configured to receive said calibration pulse and in response determine and store a future time stamp value and a new time value, said one or more slave CMTS devices are further configured to synchronize with said master CMTS device by resetting a local counter at each of said one or more slave CMTS devices to said new time value upon receiving an internal signal generated by each of said one or more slave CMTS devices.

8. The system of claim 7, wherein said internal signal is generated by each of said one or more slave CMTS devices when a current time value of each of said one or more slave CMTS devices is equal to said future time stamp value stored at each of said one or more slave CMTS devices.

9. The system of claim 8, wherein said future time stamp value for each of said one or more slave CMTS devices is determined as a function of its current time value and a program buffer value, wherein said program buffer value represents a time period needed to program each of said one or more CMTS devices.

10. The system of claim 9, wherein said new time value for each of said one or more slave CMTS devices is determined as a function of latency, said program buffer value, and a time differential value between said master CMTS device and said one or more slave CMTS devices.

11. The system of claim 9, wherein said new time value for each of said one or more slave CMTS devices is determined as a function of latency, said program buffer value, and an absolute time value of said master CMTS device.
